(19) United States
(12) Patent Application Publication
(10) Pub. No.: US 2017/0058105 A1
(43) Pub. Date: Mar. 2, 2017

(54) ELECTRICALLY CONDUCTIVE POLYCARBONATE COMPOUNDS

(71) Applicant: POLY ONE CORPORATION, Avon Lake, OH (US)

(72) Inventors: Kebin GENG, Solon, OH (US); Jane SPIKOWSKI, Westlake, OH (US); Joseph C. GOLBA, Avon Lake, OH (US)

(73) Assignee: PolyOne Corporation, Avon Lake, OH (US)

(21) Appl. No.: 15/038,796

(22) PCT Filed: Nov. 24, 2014
(86) PCT No.: PCT/US2014/067185

§ 371 Date: May 24, 2016

Related U.S. Application Data
(60) Provisional application No. 61/909,908, filed on Nov. 27, 2013.

(51) Int. Cl. C08K 7/24; C08L 69/00; C08K 7/06; H01B 1/24; C08K 7/14

(52) U.S. Cl. CPC C08K 7/24; H01B 1/24; C08K 7/14; C08K 7/06; C08L 69/00; C08K 2201/001; C08K 2201/011

(57) ABSTRACT

An electrically conductive polymer compound is disclosed. The compound comprises a matrix comprising polycarbonate and carbon nanotubes dispersed in the matrix. The carbon nanotubes are disaggregated and disagglomerated within the polycarbonate, when the compound is viewed at 20,000× magnification. The compound is useful for making extruded plastic sheet, molded objects, or other plastic articles that need electrical properties.

### CLAIM OF PRIORITY

This application claims priority from U.S. Provisional Patent Application Ser. No. 61/909,908 bearing Attorney Docket Number 12013042 and filed on Nov. 27, 2013, which is incorporated by reference.

### FIELD OF THE INVENTION

This invention concerns polycarbonate compounds which have electrical properties.

### BACKGROUND OF THE INVENTION

Thermoplastic articles can be superior to metal because they do not corrode and can be molded or extruded into any practical shape. Thermoplastic articles are also superior to glass because they do not shatter when cracking.

Thermoplastic articles can be made to be electrically conductive if sufficient amounts of electrically conductive particles are dispersed in the articles. Many types of articles need to be electrically conductive, and neither metal nor glass articles is practical.

### SUMMARY OF THE INVENTION

Therefore, what the art needs is an electrically conductive thermoplastic compound that can be used to make thermoplastic articles for use in electrically conductive circumstances, particularly where the surface of the thermoplastic article needs to have at least low surface electrical resistivity or even electrical conductivity.

The art also needs an electrically conductive thermoplastic compound that is durable, so that the thermoplastic article can function in circumstances where the article encounters friction against other materials.

The present invention has solved that problem by relying on polycarbonate polymer to provide durability, with electrically conductive particles dispersed therein. Moreover, the present invention has found that carbon nanotubes can be the only type of electrically conductive particle dispersed in the polycarbonate in order to minimize the effect on mechanical properties on polycarbonate than if other conductive fillers, such as carbon black and metallic fillers, were used.

Thus, one aspect of the invention is an electrically conductive thermoplastic compound, comprising (a) polycarbonate and (b) carbon nanotubes dispersed, in an amount ranging from about 0.1 to about 10 weight percent of the compound, in the polycarbonate, without aggregation or agglomeration of nanotubes in the polycarbonate when the compound is viewed at 20,000× magnification.

Features of the invention will be explained below in relation to the following drawings.

### BRIEF DESCRIPTION OF THE DRAWING

FIG. 1 is a collection of carbon nanotubes as delivered from the vendor viewed at 15,000× magnification.

FIG. 2 is a collection of carbon nanotubes as delivered from the vendor viewed at 25,000× magnification.

FIG. 3 is a collection of carbon nanotubes as delivered from the vendor viewed at 50,000× magnification.

FIG. 4 is a collection of carbon nanotubes as delivered from the vendor viewed at 100,000× magnification.

FIG. 5 is a microtome section of the compound of the invention as a molded bar viewed at 20,000× magnification.

FIG. 6 is a microtome section of the compound of the invention as a molded bar viewed at 50,000× magnification.

FIG. 7 is a microtome section of the compound of the invention as a molded bar viewed at 100,000× magnification.

FIG. 8 is a microtome section of the compound of the invention as an extruded sheet strip viewed at 20,000× magnification.

FIG. 9 is a microtome section of the compound of the invention as an extruded sheet strip viewed at 50,000× magnification.

FIG. 10 is a microtome section of the compound of the invention as an extruded sheet strip viewed at 100,000× magnification.

### EMBODIMENTS OF THE INVENTION

Polycarbonate

Any polycarbonate is a candidate for use in the compound, whether obtained from petrochemical or bio-derived sources, whether virginal or recycled.

Polycarbonates can be branched or linear. Polycarbonates can be aromatic or aliphatic. Without undue experimentation, one of ordinary skill in the art can select a polycarbonate matrix based on considerations of cost, manufacturing technique, physical properties, chemical properties, etc.

Commercial manufacturers of polycarbonate are SABIC, Bayer, Teijin, Dow, and many others.

Carbon Nanotubes

The carbon nanotubes are used in this present invention, expressly to the exclusion of other types of carbonaceous conductive particles. The reason, for the selection of carbon nanotubes, is based on the tremendous electrically conductivity that can be achieved with them, as compared to other types of electrically conductive particles, whether metallic or non-metallic or both. Relatively small amounts of carbon nanotubes, with their considerably large aspect ratios, provide a surface resistivity of less than 10¹² ohms/square in compounds of the present invention.

Carbon nanotubes have aspect ratios ranging from 10:1 to 10,000:1 and are surprisingly excellent for dispersion within PC, as demonstrated by the microphotographic evidence of the Figures.

Carbon nanotubes are categorized by the number of walls. The present invention can use either single-wall nanotubes (SWNT), double-wall nanotubes (DWNT) or multi-wall nanotubes (MWNT) or their combination.

To achieve such aspect ratios, nanotubes can have a length ranging from about 1 μm to about 10 μm, and preferably from about 1 μm to about 5 μm and a width or diameter ranging from about 0.5 nm to about 1000 nm, and preferably from about 0.6 nm to about 100 nm.

Also, such conductive media should have resistivities ranging from about 1×10⁻⁸ Ohm·cm to about 3×10² Ohm·cm, and preferably from about 1×10⁻⁶ Ohm·cm to about 5×10⁻¹ Ohm·cm.

More information about MWNT can be found at U.S. Pat. No. 4,663,230 (Tennent). More information about DWNT can be found at U.S. Pat. No. 8,182,782 (Moraysky et al.) More information about SWNT can be found in U.S. Pat. No. 6,692,717 (Smalley et al.)

Non-limiting examples of suppliers of carbon nanotubes, either SWNT, DWNT, MWNT, or their combination are Unidym, Inc. (formerly Carbon Nanotechnologies) of Houston, Tex.; Hyperion Catalysis International of Cambridge, Mass.; Arkema; Catalytic Materials of Pittsboro, N.C.; Apex Nanomaterials of San Diego, Calif.; Cnano Technologies of Menlo Park, Calif.; NanoIntegries of Menlo Park, Calif.; Hanwha Nanotech of Incheon, Korea; Nanocyl of Belgium; Raymor Industries of Boisbriand, Quebec, Canada; and dozens more.

Particularly preferred is FloTub™ 9000 H MWNT from Cnano Technologies.

The carbon nanotubes can be added at the time of melt compounding of the PC, fed downstream of the throat after suitable melting of the PC has occurred, or can be made into a masterbatch to facilitate a two-step process of dispersion into the ultimate thermoplastic compound.

Though it has been viewed as preferable for the masterbatch route to be used, because carbon nanotubes are extraordinarily small particles need special equipment to be dispersed into a matrix, unexpectedly and quite surprisingly, the use of PC as the melt polymer generates such levels of dispersion that no aggregates or agglomerates of the carbon nanotubes can be found in Scanning Electron Microscopy (SEM) of up to 20,000× magnification and even 50,000× or 100,000× magnifications.

Optional Second Polymer

Optionally, any polymer which is compatible and preferably miscible with PC can be used in a blend with PC to achieve particular processing or performance properties when making thermoplastic articles. Without undue experimentation, one skilled in the art can determine which polymers are suitable for blending with PC and select from them. Non-limiting examples of such polymers include acrylonitrile-butadiene-styrene (ABS), polybutylene terephthalate (PBT), polylactic acid (PLA), or impact modified or flame retardant versions thereof. These optional polymers are available commercially from a number of manufacturers.

Optional Glass Fibers

Glass fibers are known as useful filler because they can provide reinforcement to a polymer compound. Therefore, glass fibers are optional for use in this invention.

Non-limiting examples of glass fibers are chopped strands, long glass fiber, and the like.

Glass fiber is commercially available from a number of sources, but ThermoFlow brand glass fibers from Johns Manville are particularly preferred, including ThermoFlow chopped glass fiber strand grade 768 for use with PC. Grade 768 has a silane based sizing to assist in dispersion of the glass fibers in such high temperature thermoplastic resins as PC. Grade 768 is made from E glass and has a typical diameter of 10 micrometers and a typical length of 4 millimeters.

Optional Carbon Fiber

Any carbon fiber optionally is useful in the present invention to provide both reinforcement and either additional conductivity or resistivity, as desired. Useful types of carbon fiber include pitch-based carbon fiber (known for its electrical resistivity) and carbon fiber derived from polyacrylonitrile (PAN) (known for its conductivity). Carbon fibers have large aspect ratios in spite of their short lengths. For example, carbon fibers easily can have aspect ratios greater than 10:1 (L/W).

Optional Other Additives

While carbon nanotubes serve as the only electrically conductive particles, the compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; catalyst deactivators, and combinations of them.

Ingredients

Table 1 shows the acceptable, desirable, and preferred amounts of each of the ingredients discussed above, recognizing that the optional ingredients need not be present at all. The compound can comprise the ingredients, consist essentially of the ingredients, or consist of the ingredients. All amounts are expressed in weight percent of the total compound.

TABLE 1
Range of Ingredients

| | Acceptable | Desirable | Preferable |
|---|---|---|---|
| Polycarbonate Polymer | 5-94 | 30-89 | 51-84 |
| Carbon Nanotubes | 0.1-10 | 0.5-7 | 2-5 |
| Optional Second Polymer | 0-50 | 0-30 | 0-20 |
| Optional Glass Fibers | 0-65 | 0-40 | 0-35 |
| Optional Carbon Fibers | 0-40 | 0-30 | 0-20 |
| Optional Other Additives | 0-10 | 0-5 | 0-3 |

Processing

The preparation of compounds of the present invention is uncomplicated. The compound of the present can be made in batch or continuous operations. As mentioned above, it is possible to have the carbon nanotubes be initially dispersed into a concentrated masterbatch by experts who work with carbon nanotubes regularly and have the equipment and expertise to provide an excellent dispersion.

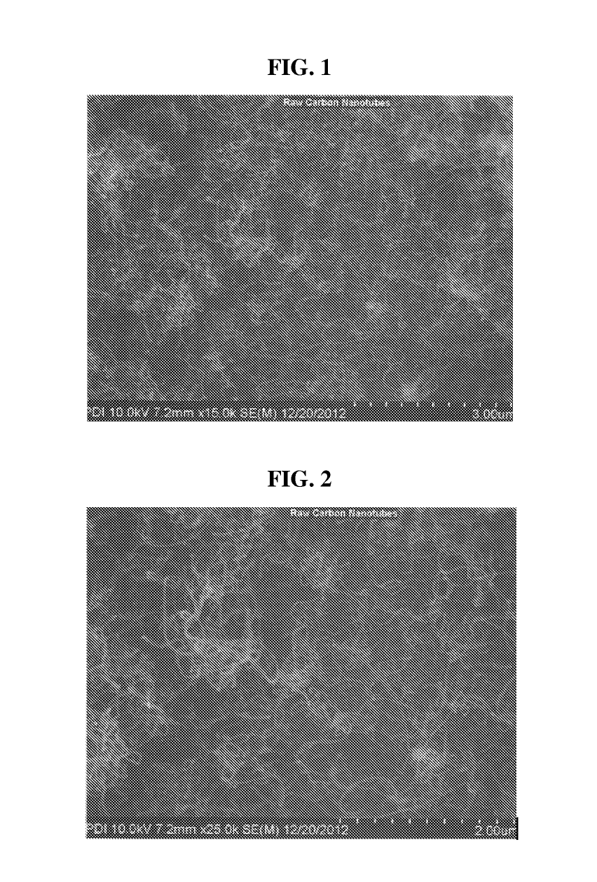

But, significantly, this invention has shown that raw, fluffy tangles of nanotubes delivered into and well mixed within a melt-mixing vessel can result in total disaggregation and total disagglomeration when the compound is viewed at 20,000×; 50,000×; and even 100,000× magnification. The Examples below shows that result in conjunction with FIGS. 1-10.

Mixing in a continuous process typically occurs in a single or twin screw extruder that is elevated to a temperature that is sufficient to melt the PC polymer matrix with addition of other ingredients either at the head of the extruder or downstream in the extruder. Extruder speeds can range from about 100 to about 1200 revolutions per minute (rpm), while the “desired range” is more like 300 rpm to 1000 rpm, and preferably from about 500 to about 900 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 100 to 600 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.elsevier.com), one can make articles of any conceivable shape and appearance using compounds of the present invention.

The extrusion process can include formation of sheet or film or the formation of profiles, depending the shape of the extrusion die(s). Alternatively, pultrusion can be used when the profile is intended to have continuous fiber reinforcement such as using fiberglass or carbon fiber for that rigidity.

Alternatively, one can use compounds of the invention in calendering, thermoforming, or even possibly 3D-printing.

### USEFULNESS OF THE INVENTION

Compounds of the present invention can be molded into any shape which benefits from having electrically conductive or static dissipative surfaces, high stiffness in thin wall sections, and a low coefficient of thermal expansion. Compounds of the present invention can be used by anyone who purchases Stat-Tech brand conductive polymer compounds from PolyOne Corporation (www.polyone.com) for a variety of industries, such as the medical device industry or the electronics industry where disposable or recyclable plastic articles are particularly useful in laboratory or manufacturing conditions.

Examples of electronics industry usage includes media carriers, process combs, shipping trays, printed circuit board racks, photomask shippers, carrier tapes, hard disk drive components, sockets, bobbins, switches, connectors, chip trays, wafer carriers, casing material for electronic articles (such as mobile phones, measurement devices, hard disk drives, medical devices, and military devices), carrier tape, Front Opening Unified Pods (FOUPs), and sensors, etc. PC compounds can withstand high temperatures, making them even more useful than less high performance polymers such as polyolefins, PLA and ABS.

Examples of medical industry usage includes electromagnetic interference shielding articles, tubing, drug inhalation devices, laboratory pipette tips, implantable medical device components, biomedical electrodes, and other devices that need protection from electrostatic discharge, static accumulation, and electromagnetic interference. PC compounds can replace stainless steel in medical applications and certain grades of commercial PC are compliant with USP Class VI guidelines and ISO 10993-1. Compounds of the present invention can be both electrically conductive and resistant to medical sterilization methods. Examples further identify aspects of the invention.

### EXAMPLES

### Examples 1-14 and Comparative Example A

Table 2 shows the ingredients used. Tables 3 and 4 show the formulations in weight percent, the processing conditions, the sheet or molding conditions, and the test results.

TABLE 2
Source of Ingredients

| Ingredient Name | Commercial Source |
|---|---|
| Lexan ™ IR2240 polycarbonate | SABIC Innovative Plastics |
| resin | |
| FloTub ™ 9000 H multiwall | CNano Technology |
| carbon nanotube (CNT) | |
| CONDUCTEX ® 7055 Ultra ® | Columbian Chemicals |
| conductive carbon black (CB) | |
| Graphistrength C100 CNT | Arkema |
| Hanwha CM-130 CNT | Hanwha |

TABLE 3
Recipes, Preparation, and Properties

| Example | 1 | 2 | 3 | 4 | 5 | 6 | Comp. A |
|---|---|---|---|---|---|---|---|
| Lexan ™ IR2240 PC | 99.0 | 98.0 | 97.5 | 97.0 | 96.0 | 95.0 | 78.0 |
| resin | | | | | | | |
| FloTub ™ 9000H CNT | 1.0 | 2.0 | 2.5 | 3.0 | 4.0 | 5.0 | |
| CONDUCTEX ® 7055 | | | | | | | 22.0 |
| Ultra ® CB | | | | | | | |
| Mixing Equipment | 18 mm Leistritz TSE with 60:1 L/D (screw length/screw diameter) | | | | | | Century TSE-30 with |
| | | | | | | | 40:1 L/D |
| Mixing Temp. | 280 C.~300 C. | | | | | | 250 C.~260 C. |
| Mixing Speed | 900 RPM | | | | | | 250 RPM |
| Order of Addition of | PC fed in main hopper; CNT side-fed in Zone 5 | | | | | | PC fed in main |
| Ingredients | | | | | | | hopper; CB side-fed |
| | | | | | | | in downstream close |
| | | | | | | | to the die exit. |
| Form of Product After | Pellets | | | | | | Pellets |
| Mixing | | | | | | | |
| Injection molding | Demag 120 Ton | | | | | | Demag 120 Ton |
| conditions for 0.125 | 293 C.-310 C.; 75 RPM; 0.8 in/sec | | | | | | 288 C.-299 C.; |
| inch thick disc of 2.5 | | | | | | | 100 RPM; 0.8-1.2 |
| inches diameter | | | | | | | in/sec |
| Description | 1% CNT | 2% CNT | 2.5% CNT | 3% CNT | 4% CNT | 5% CNT | 22% CB |
| Surface Resistivity | 1.31E+13 | 1.86E+12 | 2.67E+09 | 4.34E+06 | 5.12E+05 | 1.38E+05 | 2.4E+04 |
| (ASTM D257); Ohm/sq. | | | | | | | |
| Dynatup Impact | No test | No test | No test | 59.9 | No test | 61 | 3.2 |
| Strength at room | | | | | | | |
| temperature, ½″ | | | | | | | |
| diameter dart; ft-lbs | | | | | | | |
| (ASTM D 1238) | | | | | | | |
| Izod, ⅛″ at room | No test | No test | No test | No test | No test | No test | 0.97 Completely |
| temperature; | | | | | | | Broken |
| ft-lbs/in | | | | | | | |
| (ASTM D-256) | | | | | | | |
| Melt Flow Rate at 300 C. | No test | No test | No test | 54.2 | No test | 31.8 | 27.4 |
| & 10 kg | | | | | | | |
| (ASTM D 1238) | | | | | | | |

TABLE 4
Recipes, Preparation, and Properties

| Example | 7 | 8 | 9 | 10 | 11 | 12 | 13 | 14 |
|---|---|---|---|---|---|---|---|---|
| Lexan ™ IR2240 PC | 99.0 | 98.5 | 98.0 | 97.5 | 97.0 | 95.0 | 97.0 | 98.0 |
| resin | | | | | | | | |
| FloTub ™ 9000H CNT | 1 | 1.5 | 2.0 | 2.5 | 3.0 | 5.0 | | |
| Graphistrength ® C100 | | | | | | | 3.0 | |
| CNT | | | | | | | | |
| Hanwha CM-130 CNT | | | | | | | | 2.0 |
| Mixing Equipment | 18 mm Leistritz TSE with 60:1 L/D (screw length/screw diameter) | | | | | | | |
| Mixing Temp. | 280 C.~300 C. | | | | | | | |
| Mixing Speed | 900 RPM | | | | | | | |
| Order of Addition of | PC fed in main hopper; CNT side-fed in Zone 5 | | | | | | | |
| Ingredients | | | | | | | | |
| Form of Product After | Pellets | | | | | | | |
| Mixing | | | | | | | | |
| Sheet extrusion | Killion 1.5″ Single screw extruder | | | | | | | |
| conditions for 10 mils = | Barrel temp: 260 C.-277 C.; 25 RPM; Roll temp: 82 C. | | | | | | | |
| 0.254 mm | | | | | | | | |
| Description | 1% CNT | 1.5% CNT | 2.0% CNT | 2.5% CNT | 3.0% CNT | 5.0% CNT | 3.0% CNT | 2.0% CNT |
| Surface Resistivity | 2.65E+11 | 1.03E+09 | 1.24E+07 | 3.98E+05 | 2.96E+04 | 2.74E+04 | 1.56E+05 | 1.34E+05 |
| (ASTM D257); Ohm/sq. | | | | | | | | |

The mixing temperatures were employed because too low a temperature increases viscosity, tending to cause breakage of the carbon nanotubes. The mixing speed was balanced between a speed enhancing dispersion and restraining carbon nanotube breakage. The delayed introduction of carbon nanotubes until Zone 5 on the extruder was another means to prevent the attrition between solid PC pellets and carbon nanotubes if both were to be fed together at the main throat.

Table 3 shows the progression of carbon nanotube loading from 1 weight percent to 5 weight percent (Examples 1-6) compared with carbon black loading of 22 weight percent (Comparative Example A). The range of surface resistivity results allows a person having ordinary skill in the art without undue experimentation to identify the appropriate loading in weight percent of carbon nanotubes.

Table 3 also shows the tremendous impact strength advantage provided by carbon nanotubes over carbon black with loadings for similar surface resistivity performance. Examples 4 and 6 are nearly 20 times strong when using the Dynatup Impact Strength test as compared with Comparative Example A.

Table 3 also shows the melt flow rate results for Examples 4 and 6 compared with Comparative Example A which indicates that, compared to the large loading level of the conventional carbon black filler, a very small loading level of CNT preserves the original polymer melt flow characteristics of the compound. The advantages are to allow inject molding thin-wall and complex objects and a saving of energy during processing.

Table 4 is different from Table 3 in that Table 3 provides experimental results for injection molded disks, whereas Table 4 provides experimental results for sheet of 0.254 mm thickness. It is important to understand that the same or similar formulations can result in different properties, depending on the ultimate shape of the plastic article made. Examples 1 and 7 are the same formulation but shaped into two different plastic articles. The comparison of Example sets of 1-7; 2-9-14; 4-11-13; and 6-12 need to be understood in that context. Table 4 also demonstrates that different types of CNT perform similarly in surface resistivity, such as a comparison of Example pairs 9-14 and 11-13.

Most surprisingly, and contrary to reports in the patent literature, the carbon nanotubes were not aggregated or agglomerated when viewed dispersed in the PC using magnifications of 20,000×; 50,000×; or even 100,000×.

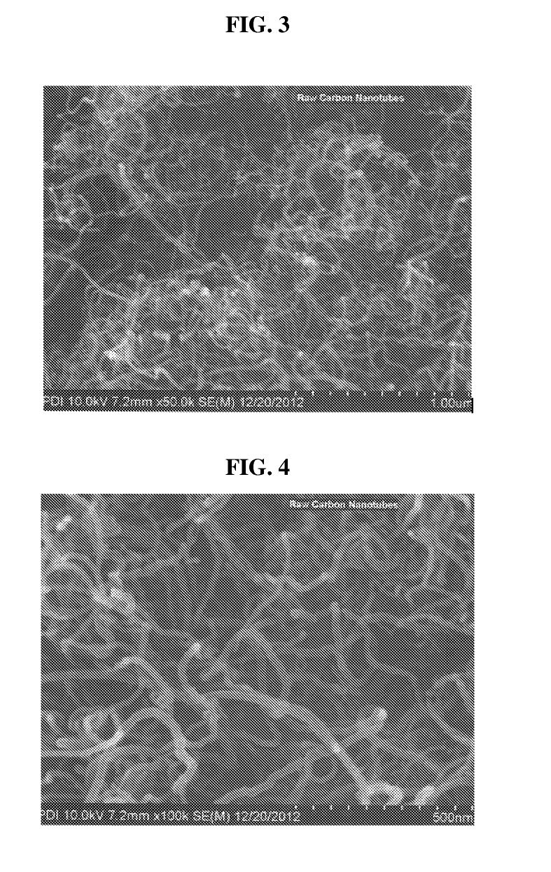

FIGS. 1-4 show Scanning Electron Microscope (SEM) views of the raw Cnano FloTub™ 9000 H multi-wall carbon nanotubes as delivered by Cnano Technologies, progressing from 15,000× magnification (FIG. 1) through to 100,000× magnification (FIG. 4). At 15,000× magnification (FIG. 1), individual nanotubes twisted and convoluted are within a non-woven nest. At 25,000× magnification (FIG. 2), there is even more identifiable individual nanotubes of twisted and jumbled orientation. At 50,000× magnification (FIG. 3), the longitudinal curvature of individual nanotubes can be seen with as much entanglement and intertwining as seen in the prior Figs. Finally, at 100,000× magnification, (FIG. 4), each individual nanotube takes on identity with thicker and thinner cross-sections along their respective lengths.

Out of the chaos as seen in FIGS. 1-4, the compound of the present invention achieves disaggregation and disagglomeration of the carbon nanotubes. Each of FIGS. 5-10 is of a 3 weight percent loading of carbon nanotubes in polycarbonate, according to Examples 4 and 11 above, respectively.

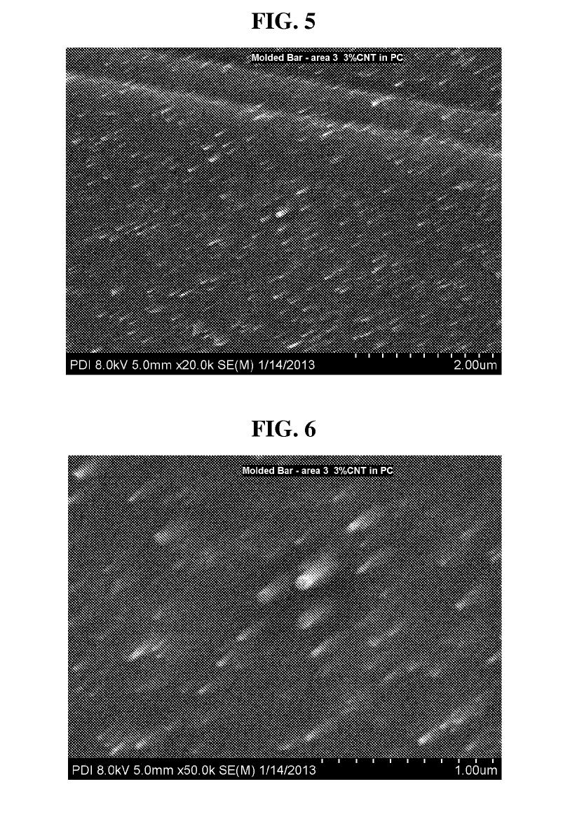

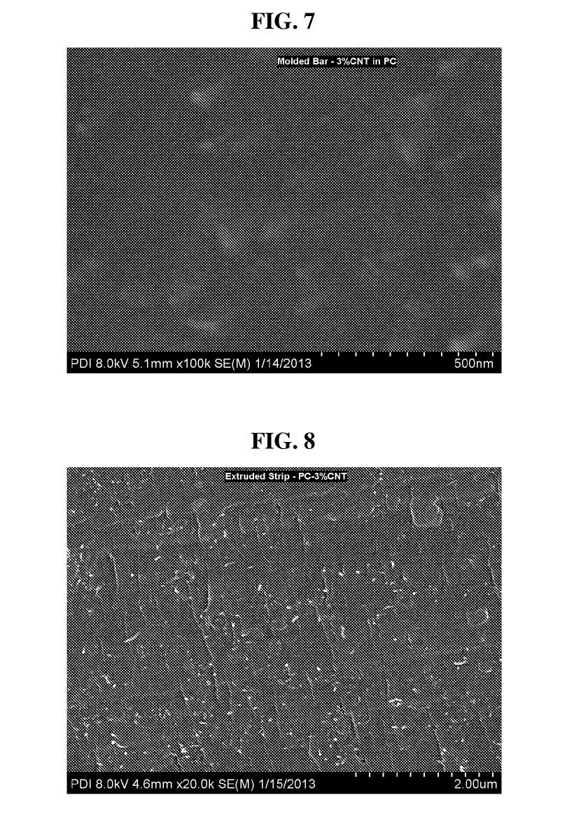

FIG. 5 is a 20,000× magnification of a molded bar. The nanotubes can be seen as not jumbled, aggregated, or agglomerated. FIG. 6 shows magnification at 50,000× and again no nanotubes are seen as jumbled, aggregated or agglomerated. FIG. 7 completes the trio of magnifications, at 100,000×. There is no aggregation or agglomeration.

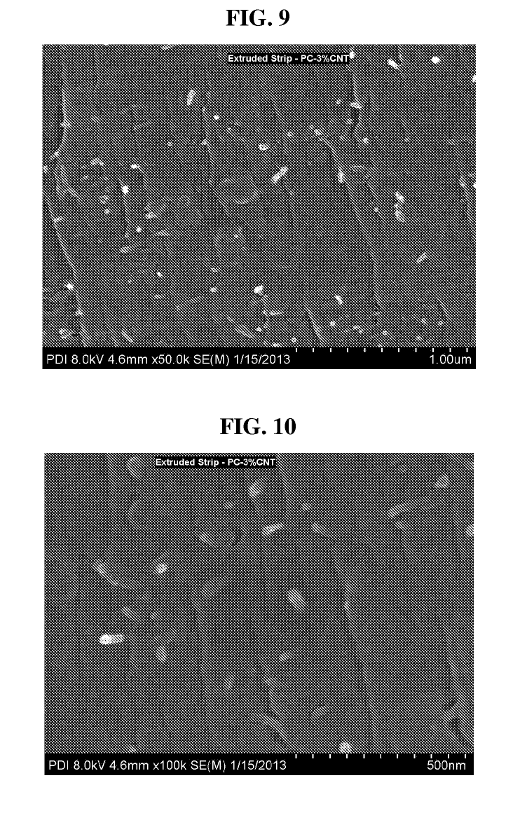

FIGS. 8-10 repeat the magnification, this time based on an extruded strip of sheet material. FIG. 8 (20,000× magnification) shows no aggregation or agglomeration of carbon nanotubes. FIG. 9 at 50.000× also shows excellent dispersion of the carbon nanotubes. FIG. 10 completes the trio, again with excellent evidence of no aggregation or agglomeration.

With such demonstration of disaggregation and disagglomeration and the other disclosures above, a person having ordinary skill in the art, without undue experimentation, could tailor the amounts of carbon nanotubes within the PC resin to achieve a variety of physical properties and a variety of resistivities for a myriad of polymer products benefiting from the maximum value of carbon nanotubes because of their dispersion as shown.

The invention is not limited to the above embodiments. The claims follow.

What is claimed is:

1. An electrically conductive thermoplastic compound, comprising
(a) polycarbonate; and
(b) carbon nanotubes dispersed, in an amount ranging from about 0.1 to about 10 weight percent of the compound, in the polycarbonate, without aggregation or agglomeration of nanotubes in the polycarbonate when the compound is viewed at 20,000× magnification.

2. The compound of claim 1, wherein the carbon nanotubes are single-wall nanotubes.

3. The compound of claim 1, wherein the carbon nanotubes are multi-wall nanotubes.

4. The compound of claim 2, further comprising an optional second polymer selected from the group consisting of acrylonitrile-butadiene-styrene, polybutylene terephthalate, polylactic acid, or impact modified or flame retardant versions thereof, and combinations thereof.

5. The compound of claim 4, further comprising fibers selected from the group consisting of glass fibers and carbon fibers and combinations thereof.

6. The compound of claim 5, further comprising an optional functional additive selected from the group consisting of adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; catalyst deactivators, and combinations of them.

7. The compound of claim 1, wherein the carbon nanotubes have an aspect ratio ranging from 10:1 to 10,000:1 and a diameter ranging from about 0.5 nm to about 1000 nm.

8. The compound of claim 1, wherein the amount of polycarbonate polymer ranges from about 5 to about 94 weight percent of the compound.

9. A molded plastic article made from the compound of claim 1.

10. A method of making a compound of claim 1, comprising the steps of
(a) melting polycarbonate in multiple zones of a twin screw extruder;
(b) at another zone downstream of the multiple zones, mixing carbon nanotubes into the melted polycarbonate.

11. The compound of claim 3, further comprising an optional second polymer selected from the group consisting of acrylonitrile-butadiene-styrene, polybutylene terephthalate, polylactic acid, or impact modified or flame retardant versions thereof, and combinations thereof.

12. The compound of claim 2, wherein the carbon nanotubes have an aspect ratio ranging from 10:1 to 10,000:1 and a diameter ranging from about 0.5 nm to about 1000 nm.

13. The compound of claim 3, wherein the carbon nanotubes have an aspect ratio ranging from 10:1 to 10,000:1 and a diameter ranging from about 0.5 nm to about 1000 nm.

14. The compound of claim 4, wherein the carbon nanotubes have an aspect ratio ranging from 10:1 to 10,000:1 and a diameter ranging from about 0.5 nm to about 1000 nm.

15. The compound of claim 2, wherein the amount of polycarbonate polymer ranges from about 5 to about 94 weight percent of the compound.

16. The compound of claim 3, wherein the amount of polycarbonate polymer ranges from about 5 to about 94 weight percent of the compound.

17. The compound of claim 4, wherein the amount of polycarbonate polymer ranges from about 5 to about 94 weight percent of the compound.

18. A molded plastic article made from the compound of claim 2.

19. A molded plastic article made from the compound of claim 3.

20. A molded plastic article made from the compound of claim 4.
